(19) United States
(12) Patent Application Publication
(10) Pub. No.: US 2020/0336783 A1
(43) Pub. Date: Oct. 22, 2020

(54) TELEVISION USER IDENTITY IDENTIFICATION METHOD AND TELEVISION TERMINAL

(71) Applicant: NIELSEN-CCDATA MEDIA RESEARCH CO., LTD., Hangzhou City (CN)

(72) Inventors: Hong ZHANG, Hangzhou City (CN); Chunxiao LIN, Hangzhou City (CN)

(73) Assignee: NIELSEN-CCDATA MEDIA RESEARCH CO., LTD., Hangzhou City (CN)

(21) Appl. No.: 16/723,435

(22) Filed: Dec. 20, 2019

(30) Foreign Application Priority Data
Apr. 16, 2019 (CN) 201910303548.6

(51) Int. Cl. H04N 21/4363; G06F 16/9535; H04N 21/643; H04N 21/64; H04N 21/45; H04N 21/466; H04N 21/462

(52) U.S. Cl. CPC H04N 21/4363; G06F 16/9535; H04N 21/64322; H04N 21/462; H04N 21/4532; H04N 21/4667; H04N 21/64

(57) ABSTRACT

This disclosure provides a television user identity identification method and a television terminal, a two-dimensional code including a local service access address is displayed so that a user terminal accesses the local service access address after scanning the two-dimensional code, the IP of the user terminal accessing the local service is obtained; and the user identity is identified according to the IP. That is, the local service access address is carried by the two-dimensional code, the IP of the user terminal is obtained when a user scans the two-dimensional code to access the local service, and then the device identifier in the router is queried according to the IP, and the identity of the user can be obtained according to the device identifier, thereby solving the problem that the television media cannot effectively obtain the identity of the user and thus cannot perform targeted marketing promotion, resulting in poor television user experience, serious user loss, and so on.

### CROSS-REFERENCE TO RELATED APPLICATION

The present application claims the priority of Chinese patent application No. 201910303548.6 filed on Apr. 16, 2019, the contents of which are incorporated herein by reference.

### FIELD OF THE INVENTION

The present invention relates to the field of television media, and in particular, to a television user identity identification method and a television terminal.

### BACKGROUND OF THE INVENTION

In recent years, emerging media (such as express envelope advertisement, digital magazines, digital newspapers, digital broadcasting, mobile phone short messages, mobile television, network, desktop windows, digital television, digital films, touch media and the like) has developed rapidly with a wide range of propagation, the viewing modes and manners of selecting and obtaining information of the audience have become increasingly diverse, and these factors have brought great impact and challenges to the propagation of the television media.

In the new media environment, the advantages of the television media as a communication platform starts to weaken, and the television media must “change in time” according to the new environment to have a new way out.

For example, a multichannel communication platform can perform targeted marketing promotion to users by using the Internet big data, for example, push advertising news that are interested to the users. However, because the television media cannot effectively obtain the identity of the users and thus cannot achieve targeted marketing promotion, which makes poor television user experience and serious user loss.

### SUMMARY OF THE INVENTION

In view of this, the present invention provides a television user identity identification method, a television terminal, an electronic device, and a computer readable storage medium, wherein a local service access address is carried by a two-dimensional code, a IP of a user terminal is obtained when a user scans the two-dimensional code to access the local service, and then a device identifier in a router is queried according to the IP, and the identity of the user can be obtained according to the device identifier, thereby solving the problem that the television media cannot effectively obtain the identity of the user and thus cannot perform targeted marketing promotion, resulting in poor television user experience, serious user loss, and so on.

In order to achieve the above object, the present invention adopts the following technical solutions:

In a first aspect, a television user identity identification method is provided, including:

displaying a two-dimensional code including a local service access address, so that a user terminal accesses the local service access address after scanning the two-dimensional code;

obtaining the IP of the user terminal accessing the local service; and

identifying the user identity according to the IP.

Further, said identifying the user identity according to the IP includes:

sending the IP to a router, so that the router obtains a corresponding device identifier according to the IP, wherein a mapping relationship between the IP and the device identifier is stored in the router;

obtaining the device identifier fedback by the router; and

querying the user identity in a database according to the device identifier.

Further, the television user identity identification method further includes:

generating the two-dimensional code.

Further, before said generating the two-dimensional code, the method further includes:

writing the local service access address in a local memory.

Further, said generating the two-dimensional code includes:

calling the local service access address in the local memory; and

generating the two-dimensional code according to the local service access address and a preset two-dimensional code generation rule.

Further, the television user identity identification method further includes:

pushing media information to a user according to the identified user identity.

Further, said pushing media information to a user according to the identified user identity includes:

obtaining historical behavior data of the user according to the identified user identity;

analyzing user behavior habits according to the historical behavior data; and

pushing the media information to the user according to the user behavior habits.

In a second aspect, a television terminal is provided, including:

a two-dimensional code display module, configured to display a two-dimensional code including a local service access address, so that a user terminal accesses the local service access address after scanning the two-dimensional code;

an IP address obtaining module, configured to obtain the IP of the user terminal accessing the local service; and

a user identity identification module, configured to identify the user identity according to the IP.

Further, the user identity identification module includes:

an IP sending unit, configured to send the IP to a router, so that the router obtains a corresponding device identifier according to the IP, wherein a mapping relationship between the IP and the device identifier is stored in the router;

a device identifier obtaining unit, configured to obtain the device identifier fedback by the router; and

a user identity query unit, configured to query the user identity in a database according to the device identifier.

Further, the television terminal further includes:

a two-dimensional code generation module, configured to generate the two-dimensional code.

Further, the television terminal further includes:

a writing module, configured to write the local service access address in a local memory.

Further, the two-dimensional code generation module includes:

a calling unit, configured to call the local service access address in the local memory; and

a two-dimensional code generation unit, configured to generate the two-dimensional code according to the local service access address and a preset two-dimensional code generation rule.

Further, the television terminal further includes:

a media information pushing module, configured to push media information to a user according to the identified user identity.

Further, the media information pushing module includes:

a historical data obtaining unit, configured to obtain historical behavior data of the user according to the identified user identity;

a user analysis unit, configured to analyze user behavior habits according to the historical behavior data; and

an information pushing unit, configured to push the media information to the user according to the user behavior habits.

In a third aspect, an electronic device is provided, including: a memory, a processor, and a computer program stored on the memory and executable on the processor, and the processor implements the following operations while executing the program:

displaying a two-dimensional code including a local service access address, so that a user terminal accesses the local service access address after scanning the two-dimensional code;

obtaining the IP of the user terminal accessing the local service; and

identifying the user identity according to the IP.

In a fourth aspect, a computer readable storage medium is provided, wherein a computer program is stored thereon, and the computer program is executed by the processor to implement the following operations:

displaying a two-dimensional code including a local service access address, so that a user terminal accesses the local service access address after scanning the two-dimensional code;

obtaining the IP of the user terminal accessing the local service; and

identifying the user identity according to the IP.

According to the television user identity identification method, the television terminal, the electronic device and the computer readable storage medium provided by the present invention, the two-dimensional code including the local service access address is displayed, so that the user terminal accesses the local service access address after scanning the two-dimensional code; the IP of the user terminal accessing the local service is obtained; and the user identity is identified according to the IP. That is, the local service access address is carried by the two-dimensional code, the user obtains the IP of the user terminal when scanning the two-dimensional code to access the local service, and then queries the device identifier in the router according to the IP, and the identity of the user can be obtained according to the device identifier, thereby solving the problem that the television media cannot effectively obtain the identity of the user and thus cannot perform targeted marketing promotion, resulting in poor television user experience, serious user loss, and so on.

On the other hand, after the user identity is identified, the historical behavior data of the user can also be obtained according to the identified user identity; data analysis is performed according to the historical behavior data to obtain the user behavior habits; and the media information is pushed to the user according to the user behavior habits, and then interested media information is pushed to the user, thereby improving the efficiency of information promotion, and meanwhile improving the user experience, especially more targeted push can be performed when television shopping information is pushed, and the effect is more obvious.

In order that the above and other object, features and advantages of the present invention become more apparent and understandable, preferred embodiments are listed below, and a detailed description is given below in combination with appended drawings.

### BRIEF DESCRIPTION OF THE DRAWINGS

To illustrate technical solutions in the embodiments of the present application or in the prior art more clearly, a brief introduction on the drawings which are needed in the description of the embodiments or the prior art is given below. Apparently, the drawings in the description below are merely some of the embodiments of the present application, based on which other drawings can be obtained by those of ordinary skill in the art without any creative effort.

FIG. 1 is a schematic diagram of architecture among a user, a router S1 and a television terminal B1;

FIG. 2 is a schematic diagram of architecture among a user, a router S1, a television terminal B1 and a database server S2;

FIG. 3 is a first flow schematic diagram of a television user identity identification method in an embodiment of the present invention;

FIG. 4 is a second flow schematic diagram of a television user identity identification method in an embodiment of the present invention;

FIG. 5 shows specific steps of a step S300 in FIG. 3 or FIG. 4;

FIG. 6 shows specific steps of a step S500 in FIG. 4;

FIG. 7 is a structural block diagram of a television terminal in an embodiment of the present invention;

FIG. 8 is a structural diagram of an electronic device in an embodiment of the present invention.

### DETAILED DESCRIPTION OF SOME EMBODIMENTS

In order that those skilled in the art can better understand the solutions of the present application, a clear and complete description of technical solutions in the embodiments of the present application will be given below, in combination with the drawings in the embodiments of the present application. Apparently, the embodiments described below are merely a part, but not all, of the embodiments of the present application. All of other embodiments, obtained by those of ordinary skill in the art based on the embodiments of the present application without any creative effort, fall into the protection scope of the present application.

Those skilled in the art should be aware that the embodiment of the present invention can be provided as a method, a system, or a computer program product. Accordingly, the present invention can take the form of a complete hardware embodiment, a complete software embodiment, or a combination of software and hardware. Moreover, the invention can take the form of a computer program product implemented on one or more computer usable storage media (including, but not limited to, a disk memory, a CD-ROM, an optical memory or the like) including computer usable program codes.

It should be noted that the terms “include” and “have” and any variations thereof used in the specification, the claims and the drawings of the present application are intended to cover non-exclusive inclusions, for example, processes, methods, systems, products or devices including a series of steps or units are not necessarily limited to those steps or units that are clearly listed, but can include other steps or units that are not explicitly listed or inherent to such processes, methods, products or devices.

It should be noted that the embodiments in the present application and the features in the embodiments can be combined with each other without conflict. The present application will be described in detail below with reference to the drawings.

Because the television media cannot effectively obtain the user identity and thus cannot achieve targeted marketing promotion, so the television user experience is poor, and the user loss is serious.

In order to solve the above technical problems in the prior art, the embodiment of the present invention provides a television user identity identification method, wherein a local service access address is carried by a two-dimensional code, a IP of a user terminal is obtained when a user scans the two-dimensional code to access the local service, and then a device identifier in a router is queried according to the IP, and the identity of the user can be obtained according to the device identifier, thereby solving the problem that the television media cannot effectively obtain the identity of the user and thus cannot perform targeted marketing promotion, resulting in poor television user experience, serious user loss, and so on.

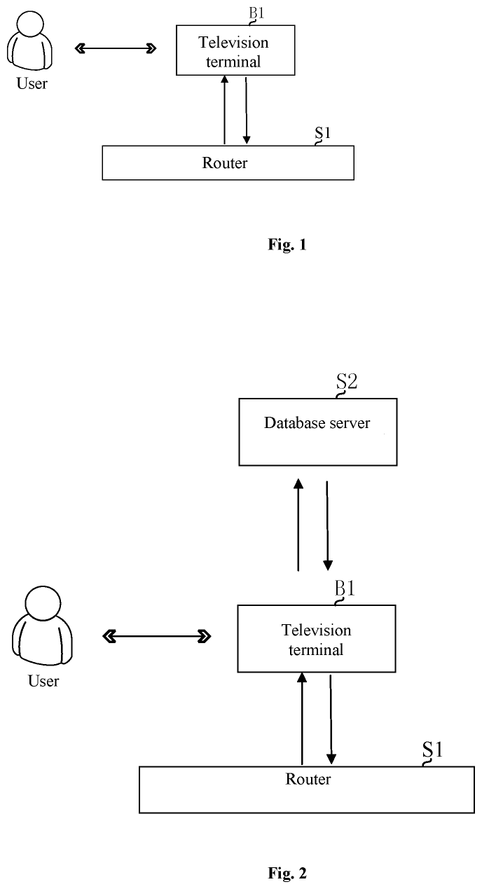

In view of this, the present application provides a television terminal B1, referring to FIG. 1, a two-dimensional code is displayed on the television terminal B1, and the user accesses the local service on the television terminal B1 after scanning the two-dimensional code, so that the television terminal B1 can obtain the IP of the user terminal, the television terminal B1 can be communicatively connected with at least one router S1, the television terminal B1 can send IP data to the router S1, and the router S1 can receive the IP data online, obtain a corresponding device identifier according to the IP data and feedback the device identifier to the television terminal B1, wherein a mapping relationship between the IP and the device identifier is stored in the router.

In addition, referring to FIG. 2, the television terminal B1 can also be communicatively connected with at least one database server S2, and the database server S2 is configured to store massive user data in the Internet. By calling the database server S2, the television terminal obtains user identity and historical behavior data according to the device identifier, analyzes user behavior habits, and then pushes television media information to the user in a targeted manner.

Based on the above contents, a display interface of the television terminal B1 is used for displaying the two-dimensional code.

In addition, the television terminal B1 is pre-loaded with an SDK program for performing the television user identity identification method provided by the embodiment of the present invention.

It can be understood that the user terminal can include a smart phone, a tablet electronic device, and the like.

In practical applications, the portion performing the television user identity identification method can be executed on the television terminal B1 side.

The database server S2, the router S1 and the television terminal B1 can communicate with one another by using any suitable network protocol, including network protocols not yet developed at the filing date of the present application. The network protocol can include, for example, the TCP/IP, the UDP/IP, the HTTP, the HTTPS, and the like. Of course, the network protocol can further include, for example, an RPC protocol (Remote Procedure Call Protocol), an REST protocol (Representational State Transfer), and the like used on the foregoing protocol.

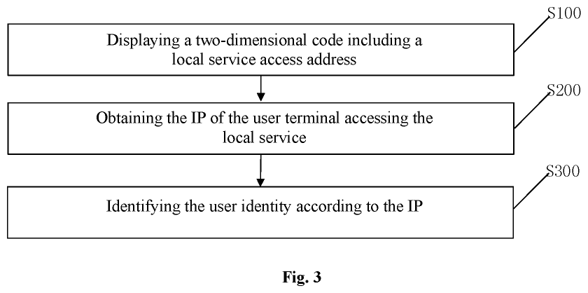

In order to be able to effectively identify the television user identity, the embodiment of the present application provides a television user identity identification method. Referring to FIG. 3, the television user identity identification method specifically includes the following contents:

Step S100: displaying a two-dimensional code including a local service access address, so that a user terminal accesses the local service access address after scanning the two-dimensional code.

The two-dimensional code can also include some related parameters (such as a local url, a local microservice address port number) and a television MAC (unique physical code).

In addition, the local service is used for providing promotion activities or push information for the user, and the user can obtain the promotion activities or interactive information of the local service after scanning the two-dimensional code.

The promotion activities or push information can include advertisement (unique identifiers of advertisement materials and advertisement landing page address URLs) or questionnaires (the question questionnaire information includes questionnaire screening questions and questionnaire formal questions), etc.

Step S200: obtaining the IP of the user terminal accessing the local service.

When the user terminal accesses the local service, the television terminal can obtain the IP address of the user terminal.

Step S300: identifying the user identity according to the IP.

Specifically, the user identity can be identified according to the IP address of the user terminal.

It can be seen from the above technical solution that, in the television user identity identification method provided by the embodiment of the present invention, the local service access address is carried by the two-dimensional code, a IP of the user terminal is obtained when a user scans the two-dimensional code to access the local service, and then the identity of the user is obtained according to the IP, thereby solving the problem that the television media cannot effectively obtain the identity of the user and thus cannot perform targeted marketing promotion, resulting in poor television user experience, serious user loss, and so on, and the television user identity identification method is suitable for television manufacturers, e-commerce platforms and advertisement monitoring companies to obtain family television user identity.

In addition, it can be understood by those skilled in the art that, by adopting the television user identity identification method provided by the embodiment of the present invention, the identity of the user in a family can not only be effectively identified, such information as the number of peoples in the family can also be obtained, which is beneficial for the television manufacturers, e-commerce platforms and advertisement monitoring companies to provide packages and other services for the family users.

In an optional embodiment, before the step S100, the method can further include:

1. Writing the local service access address in a local memory.

2. Calling the local service access address in the local memory; and

3. Generating the two-dimensional code according to the local service access address and a preset two-dimensional code generation rule.

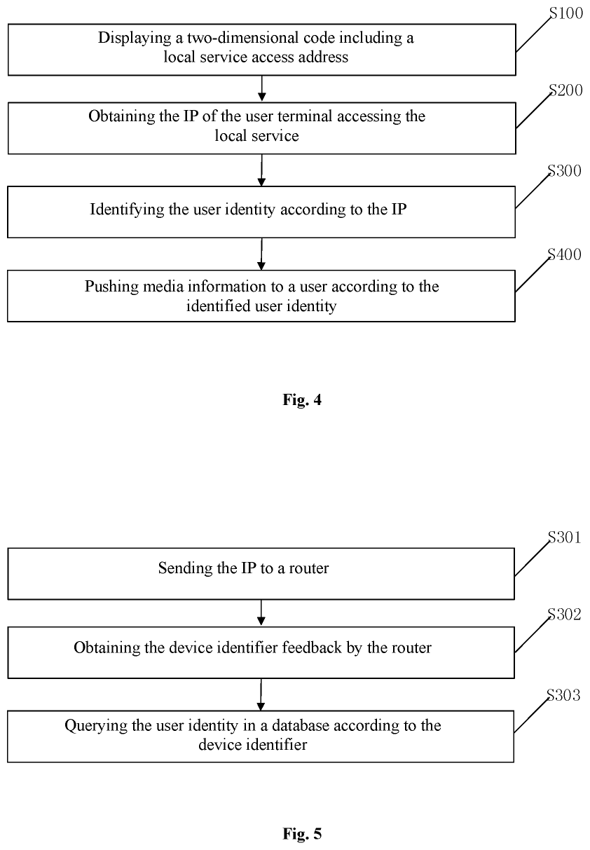

In an optional embodiment, referring to FIG. 4, the television user identity identification method can further include:

Step S400: pushing media information to a user according to the identified user identity.

Specifically, the media information that the user may be of interest is pushed to the user according to the user identity, for example, for young female users, some entertainment programs, idol dramas and the like may be pushed, and for young male users, some sports programs, military programs and the like may be pushed, for elderly users, some family dramas, historical dramas, health programs, and so on can be pushed.

Therefore, messages can be pushed to the user in a targeted manner, so that the information promotion efficiency can be effectively improved, and the user experience is improved.

FIG. 5 shows specific steps of the step S300 in FIG. 3 or FIG. 4. As shown in FIG. 5, the step S300 can include the following contents:

Step S301: sending the IP to a router, so that the router obtains and feeds back a corresponding device identifier according to the IP, wherein a mapping relationship between the IP and the device identifier is stored in the router.

The device identifier can include a terminal MAC (unique physical address code), a mobile phone number, and the like.

Step S302: obtaining the device identifier feedback by the router.

Step S303: querying the user identity in a database according to the device identifier.

By utilizing the mass big data in the existing Internet, the identity of the user and historical behavior data of the user such as shopping records, movie viewing records and the like can be obtained according to the terminal MAC or mobile phone number and the like of the user.

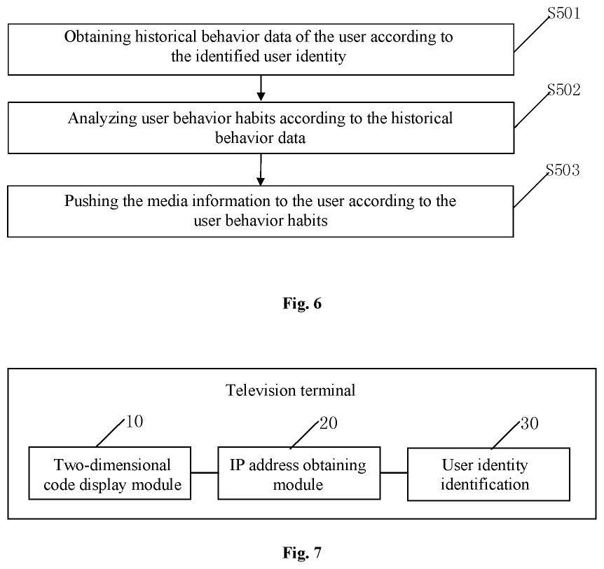

FIG. 6 shows the specific steps of the step S500 in FIG. 4. Referring to FIG. 6, the step S500 includes the following contents:

Step S501: obtaining historical behavior data of the user according to the identified user identity.

The historical behavior data can include: the shopping records, the movie viewing records and the like of the user.

Step S502: analyzing user behavior habits according to the historical behavior data.

Specifically, the preferences and recent trends of the user can be analyzed based on the historical behavior data of the user.

Step S503: pushing the media information to the user according to the user behavior habits.

For example, if the user recently purchases a lot of building materials or browses a lot of commodity information of building materials, it may indicate that the user may be renovating in the near future, then some programs and television shopping advertisement about decoration can be pushed to the user in the targeted manner when pushing the media information to the user; as another example, if the user recently purchases milk powder and baby products, some parenting programs or cartoons can be pushed to the user; and if the user browses videos of a lot of sports programs, then more sports programs can be pushed to the user, so that the user experience and the information transmission efficiency are improved.

It should be noted that the step S500 can be executed by the television terminal and can also be executed by an external server.

The SDK can be integrated into application level APPs of an Android platform thereof or Framework level APPs of the Android platform. By calling an advertisement enhancement interface (two-dimensional code) of the SDK, a two-dimensional code image file is generated locally, and then a two-dimensional code image is loaded and displayed on a screen.

Based on the same inventive concept, the embodiment of the present application further provides a television terminal, which can be used for implementing the method described in the foregoing embodiment, as in the following embodiment. Since the principle of solving the problem by the television terminal is similar to the above method, the implementation of the television terminal can be referred to the implementation of the above method, and the repeated portions are not repeatedly described. As used hereinafter, the term “unit” or “module” can implement the combination of software and/or hardware of predetermined functions. Although the apparatus described in the following embodiment is preferably implemented in software, hardware or the combination of software and hardware is also possible and contemplated.

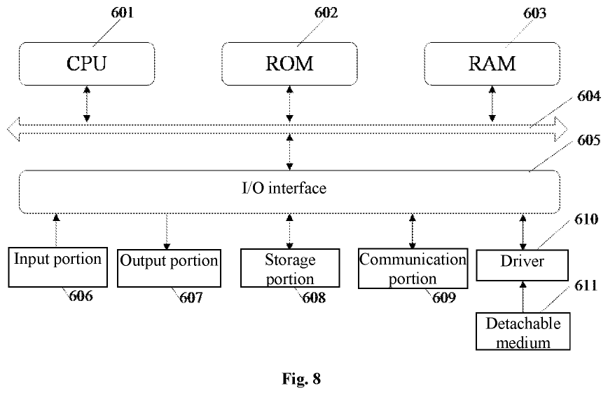

FIG. 7 is a structural block diagram of a television terminal in an embodiment of the present invention. As shown in FIG. 7, the television terminal includes a two-dimensional code display module 10, an IP address obtaining module 20, and a user identity identification module 30.

The two-dimensional code display module 10 generates and displays a two-dimensional code including a local service access address, so that a user terminal accesses the local service access address after scanning the two-dimensional code.

The two-dimensional code can also include some related parameters (such as a local url, a local microservice address port number) and a television MAC (unique physical code).

The IP address obtaining module 20 obtains the IP of the user terminal accessing the local service.

When the user terminal accesses the local service, the television terminal can obtain the IP address of the user terminal.

The user identity identification module 30 identifies the user identity according to the IP.

The user identity identification module 30 can include: an IP sending unit, a device identifier obtaining unit and a user identity query unit.

The IP sending unit sends the IP to a router, so that the router obtains and feeds back a corresponding device identifier according to the IP, wherein a mapping relationship between the IP and the device identifier is stored in the router.

The device identifier can include a terminal MAC (unique physical address code), a mobile phone number, and the like.

The device identifier obtaining unit obtains the device identifier feedback by the router.

The user identity query unit queries the user identity in a database according to the device identifier.

By utilizing the mass big data in the existing Internet, the identity of the user and historical behavior data of the user such as shopping records, movie viewing records and the like can be obtained according to the terminal MAC or mobile phone number and the like of the user.

It can be seen from the above technical solution that, in the television user identity identification method provided by the embodiment of the present invention, the local service access address is loaded by the two-dimensional code, a IP of the user terminal is obtained when a user scans the two-dimensional code to access the local service, and then the identity of the user is obtained according to the IP, thereby solving the problem that the television media cannot effectively obtain the identity of the user and thus cannot perform targeted marketing promotion, resulting in poor television user experience, serious user loss, and so on, and it is suitable for television manufacturers, e-commerce platforms and advertisement monitoring companies to obtain family television user identity.

In addition, it can be understood by those skilled in the art that, by adopting the television user identity identification method provided by the embodiment of the present invention, the identity of the user in a family can not only be effectively identified, such information as the number of peoples in the family can also be obtained, which is beneficial for the television manufacturers, e-commerce platforms and advertisement monitoring companies to provide packages and other services for the family users.

In an optional embodiment, the television terminal can further include: a writing module and a two-dimensional code generation module.

The write module is configured to write the local service access address in a local memory.

The two-dimensional code generation module can include: a calling unit and a two-dimensional code generation unit.

The calling unit calls the local service access address in the local memory.

The two-dimensional code generation unit generates the two-dimensional code according to the local service access address and a preset two-dimensional code generation rule.

In an optional embodiment, the television terminal can further include: a media information pushing module.

The media information pushing module pushes media information to a user according to the identified user identity.

Specifically, the media information that the user may be of interest is pushed to the user according to the user identity, for example, for young female users, some entertainment programs, idol dramas and the like may be pushed, and for young male users, some sports programs, military programs and the like may be pushed, for elderly users, some family dramas, historical dramas, health programs, and so on can be pushed. Therefore, messages can be pushed to the user in a targeted manner, so that the information promotion efficiency can be effectively improved, and the user experience is improved.

Specifically, the media information pushing module can include: a historical data obtaining unit, a user analysis unit, and an information pushing unit.

The historical data obtaining unit obtains historical behavior data of the user according to the identified user identity.

The historical behavior data can include: shopping records, movie viewing records and the like of the user.

The user analysis unit analyzes user behavior habits according to the historical behavior data.

Specifically, the preferences and recent trends of the user can be analyzed based on the historical behavior data of the user.

The information pushing unit pushes the media information to the user according to the user behavior habits.

For example, if the user recently purchases a lot of building materials or browses a lot of commodity information of building materials, it may indicate that the user may be renovating in the near future, then some programs and television shopping advertisement about decoration can be pushed to the user in the targeted manner when pushing the media information to the user; as another example, if the user recently purchases milk powder and baby products, some parenting programs or cartoons can be pushed to the user; and if the user browses videos of a lot of sports programs, then more sports programs can be pushed to the user, so that the user experience and the information transmission efficiency are improved.

It should be noted that the step S500 can be executed by the television terminal and can also be executed by an external server.

The apparatus, module or unit set forth in the above embodiments can be specifically implemented by a computer chip or an entity, or by a product having a certain function. A typical implementation device is an electronic device. Specifically, the electronic device can be, for example, a personal computer, a laptop computer, a cellular phone, a camera phone, a smart phone, a personal digital assistant, a media player, a navigation device, an email device, a game console, a tablet personal computer, a wearable device, or a combination of any of these devices.

In a typical example, the electronic device specifically includes a memory, a processor and a computer program stored on the memory and executable on the processor, and the processor executes the program to implement the following steps:

generating and displaying a two-dimensional code including a local service access address, so that a user terminal accesses the local service access address after scanning the two-dimensional code;

obtaining the IP of the user terminal accessing the local service; and

identifying the user identity according to the IP.

It can be seen from the above description that the electronic device provided by the embodiment of the present invention can be used for identifying the television user identity, thereby solving the problem that the television media cannot effectively obtain the identity of the user and thus cannot perform targeted marketing promotion, resulting in poor television user experience, serious user loss, and so on.

Referring now to FIG. 8, a structural schematic diagram of an electronic device 600 suitable for implementing embodiment of the present application is shown.

As shown in FIG. 8, the electronic device 600 includes a central processing unit (CPU) 601, which can execute various appropriate tasks and processes based on programs stored in a read-only memory (ROM) 602 or programs loaded from a storage portion 608 into a random access memory (RAM) 603. In the RAM 603, various programs and data required for the operation of the system 600 are also stored. The CPU 601, the ROM 602 and the RAM 603 are connected with one other through a bus 604. An input/output (I/O) interface 605 is also connected to the bus 604.

The following components are connected to the I/O interface 605: an input portion 606 including a keyboard, a mouse and the like; an output portion 607 including, for example, a cathode-ray tube (CRT), a liquid crystal display (LCD), a loudspeaker and the like; a storage portion 608 including a hard disk or the like; and a communication portion 609 including a network interface card such as an LAN card, a modem, or the like. The communication portion 609 performs communication processing via a network such as the Internet. A driver 610 is also connected to the I/O interface 606 as needed. A detachable medium 611 such as a magnetic disk, an optical disk, a magneto-optical disk, a semiconductor memory or the like is mounted on the driver 610 as needed, so that a computer program read therefrom is mounted as needed, such as the storage portion 608.

In particular, according to the embodiment of the present invention, the process described above with reference to the flow diagrams can be implemented as a computer software program. For example, the embodiment of the invention includes a computer readable storage medium, a computer program is stored thereon, and the computer program is executed by the processor to implement the following steps:

generating and displaying a two-dimensional code including a local service access address, so that a user terminal accesses the local service access address after scanning the two-dimensional code;

obtaining the IP of the user terminal accessing the local service; and

identifying the user identity according to the IP.

It can be seen from the above description that the computer readable storage medium provided by the embodiment of the present invention can be used for identifying the television user identity, thereby solving the problem that the television media cannot effectively obtain the identity of the user and thus cannot perform targeted marketing promotion, resulting in poor television user experience, serious user loss, and so on.

In such an embodiment, the computer program can be downloaded and mounted from the network via the communication portion 609, and/or mounted from the detachable medium 611.

The computer readable medium includes both permanent and non-persistent, removable and non-removable media, and can implement information storage by any method or technology. The information can be computer readable instructions, data structures, modules of programs, or other data. The example of the computer storage medium, includes, but is not limited to, a phase change memory (PRAM), a static random access memory (SRAM), a dynamic random access memory (DRAM), other types of random access memories (RAM), a read only memory (ROM), an electrically erasable programmable read only memory (EEPROM), a flash memory or other memory technologies, a compact disk-read only memory (CD-ROM), a digital versatile disk (DVD) or other optical memories, a cassette magnetic tape, a magnetic tape storage or other magnetic storage devices or any other non-transportable media can be used for storing information that can be accessed by a computing device. As defined herein, the computer readable medium does not include transitory media, such as modulated data signals and carrier waves.

For the convenience of description, the above apparatus is divided into various units for separate description when being described. Of course, the functions of the various units can be implemented in the same software or multiple software and/or hardware when the present application is implemented.

The present invention is described according to the flow diagrams and/or block diagrams of the method, device (system) and the computer program product in the embodiments of the present invention. It should be understood that computer program instructions can achieve each flow and/or block in the flow diagrams and/or block diagrams and the combination of the flows and/or blocks in the flow diagrams and/or block diagrams. These computer program instructions can be provided to a general-purpose computer, a special-purpose computer, an embedded processor or processors of other programmable data processing devices to generate a machine, such that the instructions executed by computers or the processors of other programmable data processing devices generate apparatuses used for achieving specified functions in one or more flows in the flow diagrams and/or one or more blocks in the block diagrams.

These computer program instructions can also be stored in a computer readable memory that is capable of guiding the computers or the other programmable data processing devices to work in a specific manner, so that the instructions stored in the computer readable memory generate a product including an instruction apparatus, and the instruction apparatus implements specified functions in one or more flows in the flow diagrams and/or one or more blocks in the block diagrams.

These computer program instructions can also be loaded onto the computers or the other programmable data processing devices, so that a series of operation steps are executed on the computers or the other programmable devices to generate the processing implemented by the computers, therefore the instructions executed on the computers or the other programmable devices provide steps for implementing the specified functions in one or more flows in the flow diagrams and/or one or more blocks in the block diagrams.

It should also be understood that the terms “comprise” or “include” or any other variations are intended to encompass non-exclusive inclusions, such that a process, method, commodity or device including a series of elements not only includes those elements, but also includes other elements that are not explicitly listed, or inherent elements of the process, method, commodity or device. An element defined by the statement “comprising a . . . ” does not exclude the presence of additional equivalent elements in the process, method, commodity or device including the element, without further limitation.

Those skilled in the art should be aware that the embodiment of the present application can be provided as a method, a system, or a computer program product. Accordingly, the present application can take the form of a complete hardware embodiment, a complete software embodiment, or a combination of software and hardware. Moreover, the present application can take the form of a computer program product implemented on one or more computer usable storage media (including, but not limited to, a disk memory, a CD-ROM, an optical memory or the like) including computer usable program codes.

The present application can be described in the general context of computer-executable instructions executed by a computer, such as a program module. Generally, the program module includes routines, programs, objects, components, data structures or the like for executing particular tasks or implementing particular abstract data types. The present application can also be practiced in distributed computing environments, in these distributed computing environments, tasks are executed by remote processing devices that are connected through a communication network. In the distributed computing environments, the program module can be located in both local and remote computer storage media including storage devices.

The various embodiments in the specification are described in a progressive manner, and the same or similar parts between the various embodiments can be referred to each other, and each embodiment focuses on the differences from the other embodiments. In particular, for the system embodiment, since it is basically similar to the method embodiment, the description is relatively simple, and the relevant parts can be referred to the description of the method embodiment.

The above description is only an embodiment of the present application and is not intended to limit the present application. For those skilled in the art, the present application can have various changes and modifications. Any modifications, equivalents, improvements, made within the spirit and principles of the present application, shall all fall within the scope of the claims of the present application.

1. A television user identity identification method, comprising:
displaying a two-dimensional code comprising a local service access address, so that a user terminal accesses the local service access address after scanning the two-dimensional code;
obtaining a IP of the user terminal accessing the local service; and
identifying the user identity according to the IP.

2. The television user identity identification method of claim 1, wherein said identifying the user identity according to the IP comprises:
sending the IP to a router, so that the router obtains a corresponding device identifier according to the IP, wherein a mapping relationship between the IP and the device identifier is stored in the router;
obtaining the device identifier feedback by the router; and
querying the user identity in a database according to the device identifier.

3. The television user identity identification method of claim 1, further comprising:
generating the two-dimensional code.

4. The television user identity identification method of claim 3, wherein before said generating the two-dimensional code, the method further comprises:
writing the local service access address in a local memory.

5. The television user identity identification method of claim 4, wherein said generating the two-dimensional code comprises:
calling the local service access address in the local memory; and
generating the two-dimensional code according to the local service access address and a preset two-dimensional code generation rule.

6. The television user identity identification method of claim 1, further comprising:
pushing media information to a user according to the identified user identity.

7. The television user identity identification method of claim 6, wherein said pushing media information to a user according to the identified user identity comprises:
obtaining historical behavior data of the user according to the identified user identity;
analyzing user behavior habits according to the historical behavior data; and
pushing the media information to the user according to the user behavior habits.

8. A television terminal, comprising:
a two-dimensional code display module, configured to display a two-dimensional code comprising a local service access address, so that a user terminal accesses the local service access address after scanning the two-dimensional code;
an IP address obtaining module, configured to obtain a IP of the user terminal accessing the local service; and
a user identity identification module, configured to identify the user identity according to the IP.

9. The television terminal of claim 8, wherein the user identity identification module comprises:
an IP sending unit, configured to send the IP to a router, so that the router obtains a corresponding device identifier according to the IP, wherein a mapping relationship between the IP and the device identifier is stored in the router;
a device identifier obtaining unit, configured to obtain the device identifier fedback by the router; and
a user identity query unit, configured to query the user identity in a database according to the device identifier.

10. The television terminal of claim 8, further comprising:
a two-dimensional code generation module, configured to generate the two-dimensional code.

11. The television terminal of claim 10, further comprising:
a writing module, configured to write the local service access address in a local memory.

12. The television terminal of claim 11, wherein the two-dimensional code generation module comprises:
a calling unit, configured to call the local service access address in the local memory; and
a two-dimensional code generation unit, configured to generate the two-dimensional code according to the local service access address and a preset two-dimensional code generation rule.

13. The television terminal of claim 8, further comprising:
a media information pushing module, configured to push media information to a user according to the identified user identity.

14. The television terminal of claim 13, wherein the media information pushing module comprises:
a historical data obtaining unit, configured to obtain historical behavior data of the user according to the identified user identity;
a user analysis unit, configured to analyze user behavior habits according to the historical behavior data; and
an information pushing unit, configured to push the media information to the user according to the user behavior habits.

15. An electronic device, comprising: a memory, a processor, and a computer program stored on the memory and executable on the processor, wherein the processor implements the steps of the television user identity identification method of claim 1 while executing the program.

16. A computer readable storage medium, a computer program is stored thereon, wherein the computer program is executed by a processor to implement the steps of the television user identity identification method of claim 1.
